(19) United States
(12) Patent Application Publication
(10) Pub. No.: US 2016/0346941 A1
(43) Pub. Date: Dec. 1, 2016

(54) KNIFE ASSEMBLY

(71) Applicant: A-TINA TOOLS CO., LTD., Taichung City (TW)

(72) Inventor: Kun-Chen CHEN, Taichung City (TW)

(21) Appl. No.: 14/721,234

(22) Filed: May 26, 2015

(51) Int. Cl. B26B 1/08

(52) U.S. Cl. CPC B26B 1/08

(57) ABSTRACT

A knife assembly includes a handle, a blade holder, and a blade. The blade holder is mounted on an end of the handle. The blade holder includes a blade mount, a cap, a blade holding element, and a spring. The blade mount is securely connected to the end of the handle. The cap is detachably attached to the blade mount. The blade holding element is moveably mounted between the blade mount and the cap and has a protrusion. The spring is mounted on the blade mount and has two ends respectively abutting the blade mount and the blade holding element. The blade is mounted between the blade mount and the cap and has a top edge provided with two notches. The protrusion on the blade holding element engages with one of the notches in the blade to securely hold the blade between the blade mount and the cap.

### FIELD

The present invention relates to a knife assembly, and more particularly to a knife assembly having a replaceable blade.

### BACKGROUND

This section provides background information related to the present disclosure which is not necessarily prior art.

A conventional knife assembly has a blade applied to cut objects. However, the blade will be worn off and become blunt after repeated use over time, and the blade of the conventional knife assembly is not replaceable. When the blade of the knife assembly is worn off, the whole knife assembly has to be discarded. Therefore, the conventional knife assembly causes material waste.

In addition, another conventional knife assembly having a replaceable blade is provided to solve the aforementioned problem. However, only one end of the replaceable blade of the conventional knife assembly can be applied to cut objects. When the end of the blade is worn off, the blade should be replaced with a new one.

To overcome the shortcomings, the present invention tends to provide a knife assembly to mitigate or obviate the aforementioned problems.

### SUMMARY

This section provides a general summary of the disclosure, and is not a comprehensive disclosure of its full scope or all of its features

An aspect of the invention is to provide a knife assembly.

The knife assembly has a handle, a blade holder, and a blade. The handle has an end. The blade holder is mounted on the end of the handle. The blade holder includes a blade mount, a cap, a blade holding element, and a spring. The blade mount is securely connected to the end of the handle. The cap is detachably attached to the blade mount. The blade holding element is moveably mounted between the blade mount and the cap and has a protrusion formed on the blade holding element. The spring is mounted on the blade mount and has two ends respectively abutting the blade mount and the blade holding element. The blade is mounted between the blade mount and the cap and has a top edge provided with two notches formed in a middle segment of the top edge of the blade. The protrusion on the blade holding element engages with one of the notches in the blade to securely hold the blade between the blade mount and the cap.

Other aspects, advantages and novel features of the invention will become more apparent from the following detailed description when taken in conjunction with the accompanying drawings.

### DRAWINGS

The drawings described herein are for illustrative purposes only of a selected embodiment and not all possible implementations, and are not intended to limit the scope of the present disclosure.

FIG. 1 is a perspective view of a knife assembly in accordance with the present invention;

FIG. 2 is an exploded perspective view of the knife assembly in FIG. 1;

FIG. 3 is another exploded perspective view of the knife assembly in FIG. 1;

FIG. 4 is an enlarged end view in partial section of the knife assembly in FIG. 1;

FIG. 5 is an enlarged operational end view in partial section of the knife assembly in FIG. 1;

FIG. 6 is a cross sectional side view of the knife assembly along the line A-A in FIG. 4; and

FIG. 7 is an operational cross sectional side view of the knife assembly along the line B-B in FIG. 5.

### DETAILED DESCRIPTION

An example embodiment will now be described more fully with reference to the accompanying drawings

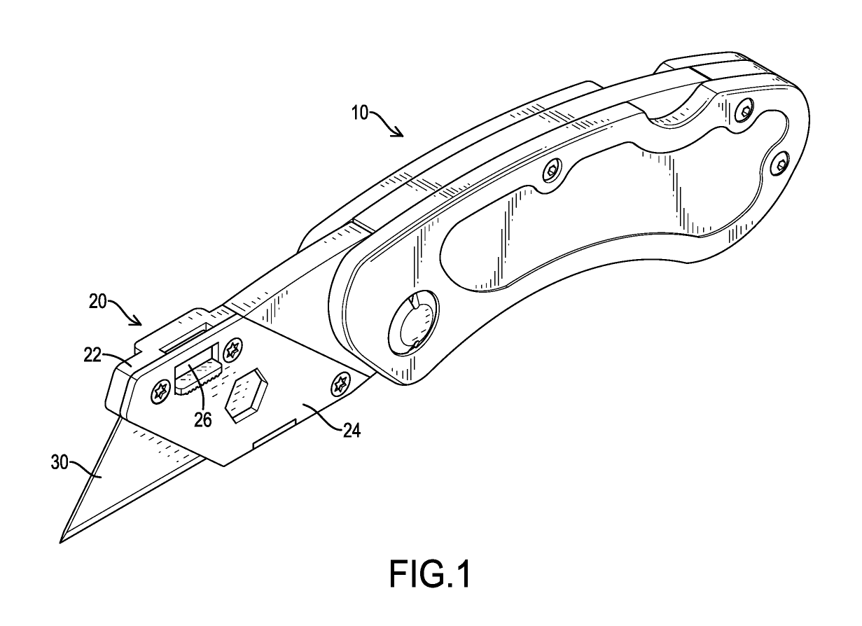

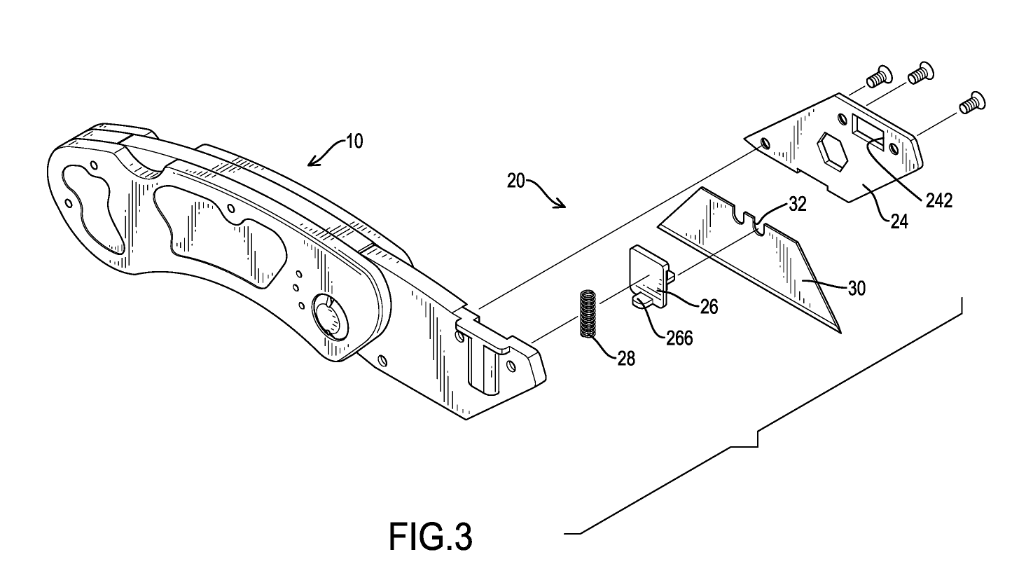

With reference to FIGS. 1 to 3, a knife assembly in accordance with the present invention comprises a handle 10, a blade holder 20, and a blade 30. The blade holder 20 is mounted on an end of the handle 10 and comprises a blade mount 22, a cap 24, a blade holding element 26, and a spring 28. The blade mount 22 is securely connected to the end of the handle 10. Preferably, the blade mount 22 is integrally formed on the end of the handle 10 as a single part. The blade mount 22 further has a spring recess 222 and a blade recess 224. The spring recess 222 is defined in the blade mount 22. The blade recess 224 is defined in the blade mount 22 and communicates with the spring recess 222.

The cap 24 is detachably attached to the blade mount 22. Preferably, the cap 24 is securely attached to the blade mount 22 by bolts. The cap 24 has a through hole 242 defined through the cap 24.

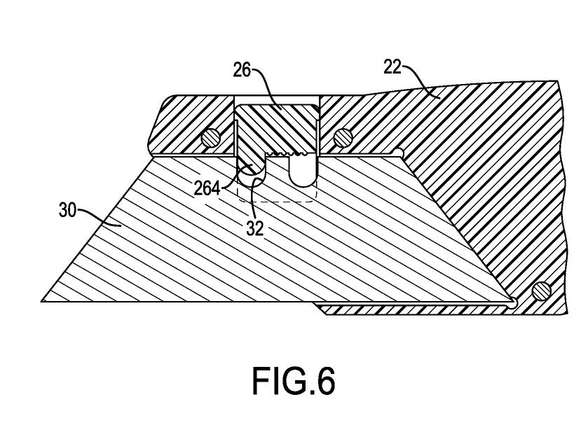

With further reference to FIG. 6, the blade holding element 26 is moveably mounted between the blade mount 22 and the cap 24 and has a push button 262, a protrusion 264, and a spring tab 266. The push button 262 is formed on and protrudes from a side of the blade holding element 26 and moveably extends through the through hole 242 in the cap 24. The protrusion 264 is formed on the blade holding element 26 and is preferably formed on a bottom surface of the push button 262. The spring tab 266 is formed on the blade holding element 26 at a side opposite the push button 262.

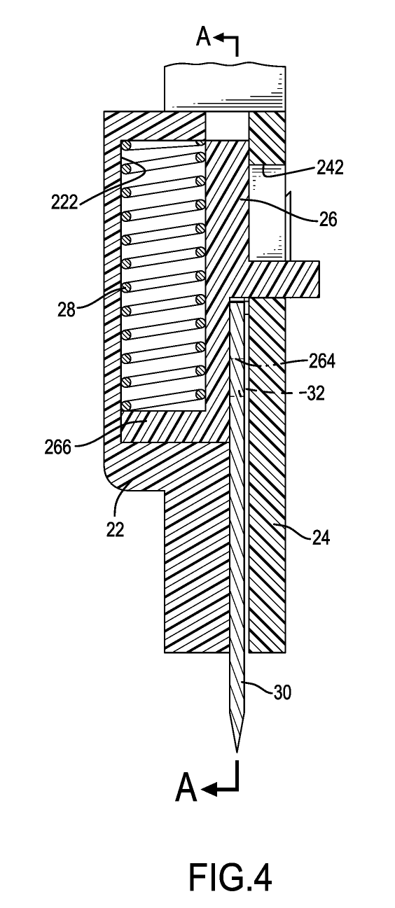

The spring 28 is mounted on the blade mount 22 and has two ends respectively abutting the blade mount 22 and the blade holding element 26. In the preferred embodiment, the spring 28 is mounted in the spring recess 222 in the blade mount 22. With further reference to FIG. 4, the two ends of the spring 28 respectively abut a top of the spring recess 222 and the spring tab 266 on the blade holding element 26.

The blade 30 is mounted between the blade mount 22 and the cap 24. One of two ends of the blade 30 is mounted in the blade recess 224 in the blade mount 22, and the other end of the blade 30 extends out of the blade recess 224. The blade 30 further has a top edge provided with two notches 32 formed in a middle segment of the top edge of the blade 30. The protrusion 264 on the blade holding element 26 selectively engages with one of the notches 32 in the blade 30 to securely hold the blade 30 between the blade mount 22 and the cap 24.

With such an arrangement, the blade 30 can be held securely on the blade holder 20 to allow a user to cut an object with the end of the blade 30 that extends out of the blade holder 20.

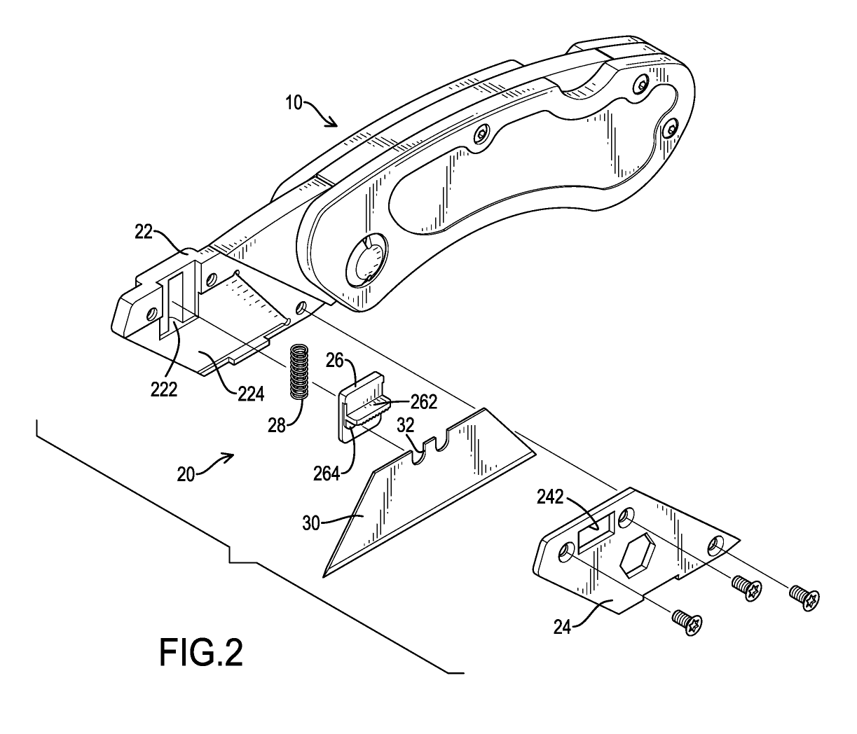

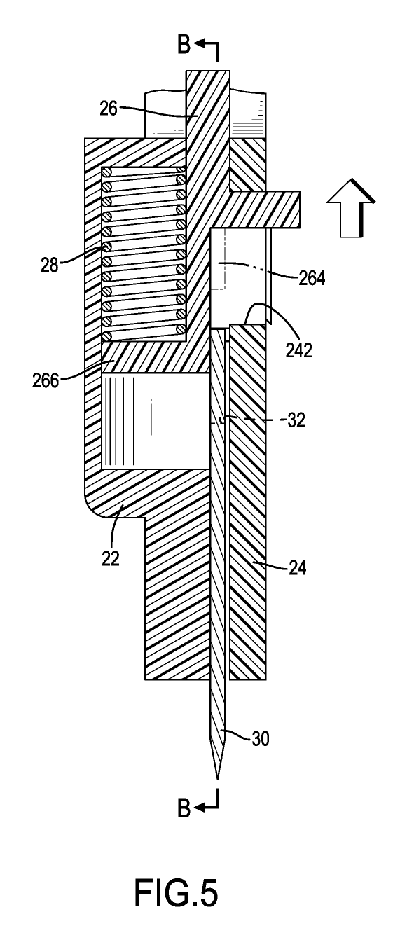

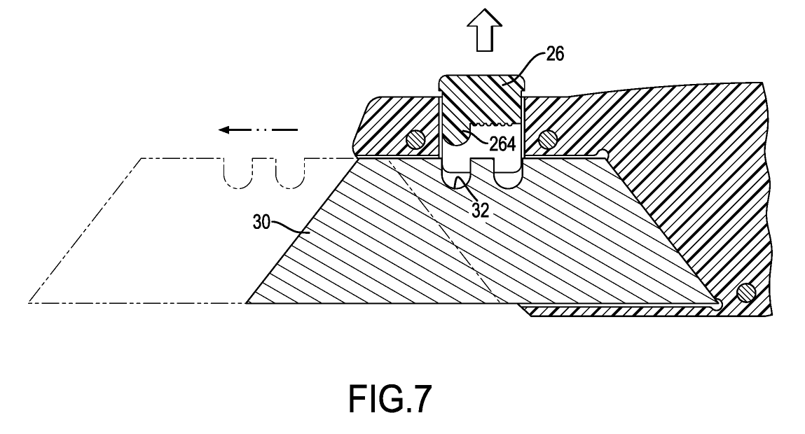

With reference to FIGS. 2 and 5 to 7, when the end of the blade 30 that extends out of the blade holder 20 is worn off, the push button 262 on the blade holding element 26 is pushed to move upward to disengage the protrusion 264 from the corresponding notch 32 in the blade 30. The spring 28 is compressed by the spring tab 266 of the blade holding element 26. Consequently, the blade 30 can be completely drawn out of the blade holder 20 and is turned for inserting the worn off end of the blade 30 into the blade recess 224. The push button 262 is then released, and the push button 262 moves downward with the recoil force provided by the spring 28 to engage the protrusion 264 with the other notch 32 in the blade 30, such that the blade 30 can be securely held in the blade holder 20 with the non-worn off end of the blade 30 extending out of the blade holder 20. Accordingly, the two ends of the blade 30 can be both and alternately applied to cut objects, so the utility of the knife assembly can be improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A knife assembly comprising:
a handle having an end;
a blade holder mounted on the end of the handle and comprising:
a blade mount securely connected to the end of the handle;
a cap detachably attached to the blade mount;
a blade holding element moveably mounted between the blade mount and the cap and having a protrusion formed on the blade holding element; and
a spring mounted on the blade mount and having two ends respectively abutting the blade mount and the blade holding element; and
a blade mounted between the blade mount and the cap and having a top edge provided with two notches formed in a middle segment of the top edge of the blade,
wherein the protrusion on the blade holding element engages with one of the notches in the blade to securely hold the blade between the blade mount and the cap.

2. The knife assembly as claimed in claim 1, wherein:
the blade mount is integrally formed on the end of the handle as a single part;
the blade mount includes a spring recess defined in the blade mount to hold the spring inside the spring recess and a blade recess defined in the blade mount and communicating with the spring recess; and
the blade has two ends, and one of the two ends of the blade is mounted in the blade recess.

3. The knife assembly as claimed in claim 2, wherein
the cap further includes a through hole defined through the cap; and
the blade holding element further has a push button formed on and protruding from a side of the blade holding element and moveably extending through the through hole in the cap.

4. The knife assembly as claimed in claim 3, wherein the protrusion of the blade holding element is formed on a bottom surface of the push button.

5. The knife assembly as claimed in claim 4, wherein the blade holding element further includes a spring tab formed on the blade holding element at a side opposite the push button and abutting one of the two ends of the spring.
